(19) United States
(12) Patent Application Publication
(10) Pub. No.: US 2026/0176435 A1
(43) Pub. Date: Jun. 25, 2026

(54) FOAMED MATERIAL AND METHOD FOR PREPARING SAME

(71) Applicant: BEIJING PHABUILDER BIOTECHNOLOGY CO., LTD., Beijing (CN)

(72) Inventors: Tao ZHANG, Beijing (CN); Xiangdong XU, Beijing (CN)

(21) Appl. No.: 18/726,710

(22) PCT Filed: Jan. 31, 2024
(86) PCT No.: PCT/CN2024/074965

§ 371 Date: Jul. 3, 2024

(30) Foreign Application Priority Data
Feb. 3, 2023 (CN) 202310053920.9

(51) Int. Cl. C08J 9/00; C08J 9/12; C08J 9/14; C08J 9/18; C08L 67/04

(52) U.S. Cl. CPC C08J 9/0023; C08J 9/0061; C08J 9/0066; C08J 9/122; C08J 9/144; C08J 9/18; C08L 67/04; C08J 2201/03

(57) ABSTRACT

The present invention relates to the technical field of biodegradable materials, and in particular, to a novel foamed material, a method for preparing same, and use thereof. The foamed material at least comprises a crystalline PHA and an amorphous PHA. The foamed material prepared by the present invention features good foaming performance. It improves the poor thermal stability, narrow processing window, low crystallization rate, and high fragility of PHA materials while retaining the original advantages and performances of the PHA materials. Therefore, the foamed material of the present invention can meet the requirements for biodegradability and certain cushion performance in applications such as high-tech appliances, packaging materials of electronic equipment, sports shoe sole materials, carpet materials, soft package materials of automotive interiors, sewage treatment materials, medical microporous foamed materials, and the like.

### TECHNICAL FIELD

The present invention relates to the technical field of biodegradable materials, and particularly, to a foamed material, a method for preparing same, and use thereof.

### BACKGROUND

Polyhydroxyalkanoates (PHAs) are macromolecular polyesters produced by microorganisms through fermentation using a variety of carbon sources, and are widely used in packaging, textiles, agriculture, biomedical materials, and other fields due to their excellent properties such as good biocompatibility, biodegradability, low carbon emission, high barrier property, and thermal processability. Particularly, PHAs can be biodegraded in industrial compost, soil (circumstances), and marine circumstances.

However, due to their poor thermal stability, narrow processing window, and low crystallization rate, the formation of spherical crystals with large sizes may lead to high fragility, and PHAs are continuously crystallized during the process of solidification, thus posing difficulties to the stable production of molded products. To overcome such problems, a modification method by blending PHAs with compatible biodegradable polymers such as polylactic acid (PLA) and polybutylene succinate (PBS) and adding various additives to form branches or crosslinks.

Since PHAs are relatively expensive compared to other polymers, they are mainly used in medical materials with high added values. However, the recent implementation of massive and industrial production of PHAs greatly reduces the manufacturing cost, thereby making the application of PHAs in packaging materials possible. In addition, as the preparation of a porous foamed material requires a smaller amount of PHAs, the development of PHA foam using a foaming agent has attracted great attention. Polymer foams may be prepared by a batch bead foaming process by adding various chemical foaming agents or using environment-friendly supercritical fluids in melt compression, and introducing the supercritical fluids into the beads in the solid state. The batch bead foaming process is conducted by foaming with supercritical carbon dioxide, where the polymer beads are infiltrated by the supercritical carbon dioxide foaming agent in a high-pressure reactor, and after maintaining the pressure for a certain period of time, the beads are expanded and foamed by a sudden pressure drop in the high-pressure reactor. Bead foaming is a process suitable for semicrystalline polymers, such as polypropylene (PP), polyurethane (TPU), and polylactic acid (PLA). The use of supercritical carbon dioxide fluid to retain the environmental friendliness of biodegradable polymers is mainly reported in polylactic acid (PLA) foams. However, it has not yet been reported in PHA foaming studies due to defects of PHAs such as poor foamability, narrow foaming temperature range, low melt strength, etc. Therefore, it is necessary to develop a biodegradable polyhydroxyalkanoate (PHA) bead foam using an eco-friendly supercritical CO₂ process.

### SUMMARY

The present invention is intended to modify the addition and preparation of PHA materials, so as to overcome the defects of PHAs such as the impossibility of PHA foaming, narrow foaming temperature range, foam breakage caused by poor melt strength, and unstable foaming quality, and to improve the foaming performance of PHAS.

In a first aspect, a foamed material comprising a substrate is provided, wherein the substrate comprises a PHA, the substrate comprises 4HB ranging from 0 wt % to 60 wt %.

Preferably, the PHA comprises a crystalline PHA and/or an amorphous PHA.

Preferably, the crystalline PHA comprises 4HB ranging from 2 wt % to 25 wt % (e.g., 0 wt %, 2 wt %, 5 wt %, 7 wt %, 10 wt %, 16 wt %, 20 wt %, or 25 wt %).

Preferably, the amorphous PHA comprises 4HB ranging from 30 wt % to 60 wt % (e.g., 30 wt %, 35 wt %, 40 wt %, 50 wt %, 55 wt %, or 60 wt %).

Preferably, the substrate comprises the crystalline PHA and the amorphous PHA; the mass ratio of the crystalline PHA and the amorphous PHA blends is in a range of 90:10 to 10:90 (e.g., 90:10, 80:20, 70:30, 60:40, 50:50, 40:60, 30:70, 20:80, or 10:90), more preferably, the mass ratio of the crystalline PHA and the amorphous PHA blends is in a range of 90:10 to 60:40, and even more preferably, the mass ratio of the crystalline PHA and the amorphous PHA blends is 70:30.

Preferably, the PHA comprises a homopolymer or a copolymer of a monomer constituting the polyhydroxyalkanoate, wherein the monomer constituting the polyhydroxyalkanoate comprises one or two or more of 2-hydroxypropionic acid, 3-hydroxypropionic acid, 3-hydroxybutyric acid, 4-hydroxybutyric acid, 3-hydroxyvaleric acid, 5-hydroxyvaleric acid, 3-hydroxyhexanoic acid, 3-hydroxyheptanoic acid, 3-hydroxyoctanoic acid, 3-hydroxynonanoic acid, 3-hydroxydecanoic acid, or 3-hydroxydodecanoic acid.

Preferably, the PHA includes, but is not limited to, one or a combination of two or more of polyhydroxybutyrate (PHB), poly-3-hydroxyvalerate (PHV), poly-3-hydroxypropionate (P3HP), poly-3-hydroxybutyrate/3-hydroxyvalerate (PHBV), poly-3-hydroxyoctanoate (PHO), poly-3-hydroxynonanoate (PHN), poly-3-hydroxybutyrate/4-hydroxybutyrate (P(3HB-co-4HB)), poly-3-hydroxybutyrate/3-hydroxyhexanoate (PHBHHx), a copolymer of hydroxy fatty acids and lactic acid (P(HA-LA)), poly-4-hydroxybutyrate (P4HB), poly-3-hydroxydecanoate (PHD), a copolymer 3-hydroxybutyrate and 3-hydroxyheptanoate (PHBHHp), a copolymer of 3-hydroxybutyric acid, 4-hydroxybutyric acid and 3-hydroxyvaleric acid (P3HB4HB3HV), or a copolymer of 3-hydroxybutyric acid, 4-hydroxybutyric acid, and 5-hydroxyvaleric acid (P3HB4HB5HV).

The HA in P(HA-LA) is a monomer for constituting the polyhydroxyalkanoate, preferably selected from one, two, or more of 3-hydroxypropionic acid, 3-hydroxybutyric acid, 4-hydroxybutyric acid, 3-hydroxyvaleric acid, 5-hydroxyvaleric acid, 3-hydroxyhexanoic acid, 3-hydroxyheptanoic acid, 3-hydroxyoctanoic acid, 3-hydroxynonanoic acid, 3-hydroxydecanoic acid, and 3-hydroxy dodecanoic acid; LA is 2-hydroxypropionic acid.

Preferably, the PHA comprises PHB and/or P(3HB-co-4HB).

Preferably, the crystalline P(3HB-co-4HB) comprises 4HB ranging from 2 wt % to 25 wt % (e.g., 2 wt %, 5 wt %, 7 wt %, 10 wt %, 16 wt %, 20 wt %, or 25 wt %).

Preferably, the amorphous P(3HB-co-4HB) comprises 4HB ranging from 30 wt % to 60 wt % (e.g., 30 wt %, 35 wt %, 40 wt %, 50 wt %, 55 wt %, or 60 wt %).

Preferably, the foaming temperature of the foamed material is in a rang of 50° C. to 145° C. (e.g., 50, 70, 90, 100, 110, 125, 130, 135, 140, or 145° C.).

Preferably, when the content of 4HB in the foamed material is 1% to 4% (preferably 2.1%), the foaming temperature is 145° C.;
when the content of 4HB in the foamed material is 4% to 9% (preferably 7%), the foaming temperature is in a range of 135° C. to 140° C.;
when the content of 4HB in the foamed material is 9% to 15% (preferably 10%), the foaming temperature is in a range of 125° C. to 130° C.;
when the content of 4HB in the foamed material is 15% to 20% (preferably 16%), the foaming temperature is in a range of 90° C. to 110° C.;
when the content of 4HB in the foamed material is 20% to 26% (preferably 25%), the foaming temperature is in a range of 70° C. to 100° C.;
when the content of 4HB in the foamed material is 26% to 30% (preferably 30%), the foaming temperature is in a range of 50° C. to 100° C.

Preferably, the foam density of the foamed material is in a range of 0.04 g/cm³ to 0.35 g/cm³.

Preferably, the expansion ratio of the foamed material is in a range of 4 to 30.

Preferably, the cell size of the foamed material is in a range of 20 μm to 145 μm.

Preferably, the cell density of the foamed material is in a range of 5.8×10⁷ cells/cm³ to 9.7×10¹⁰cells/cm³.

Preferably, the foamed material further comprises an auxiliary agent; the auxiliary agent includes, but is not limited to, one or a combination of two or more of a chain extender, an anti-hydrolysis stabilizer, a compatibilizer, a melt enhancer, a coupling agent, a solubilizer, a plasticizer, an antioxidant, a heat stabilizer, and a lubricant.

Preferably, the foamed material comprises 0.5% to 10% (e.g., 0.5%, 1%, 1.5%, 2%, 3%, 4%, 5%, 6%, 7%, 8%, 9%, or 10%) of the auxiliary agent.

Preferably, the chain extender includes, but is not limited to, one or a combination of two or more of an epoxy-functional chain extender, an oxazoline chain extender, or an isocyanate chain extender. More preferably, the chain extender is an epoxy functional group-containing agent; even more preferably, the chain extender includes, but is not limited to, at least one of glycidyl methacrylate, glycidyl acrylate, 3,4-epoxycyclohexyl methacrylate, or an ADR chain extender; still more preferably, the foamed material comprises 0.5% to 3% of the chain extender.

Preferably, the anti-hydrolysis stabilizer includes, but is not limited to, one or a combination of two or more of carbodiimide, isocyanate, epoxy, oxazoline, and anhydride anti-hydrolysis agents.

Preferably, the compatibilizer includes, but is not limited to, one or a combination of two or more of a vinyl acetate polymer, a maleic anhydride graft polymer, or glycidyl methacrylate.

Preferably, the melt enhancer includes, but is not limited to, one or two of an acrylate melt enhancer or a methacrylic acid-butadiene-styrene copolymer.

Preferably, the coupling agent includes, but is not limited to, one or a combination of two or more of a silane coupling agent, a titanate coupling agent, and an aluminate esters coupling agent.

Preferably, the solubilizer includes, but is not limited to, one or a combination of two or more of polyethylene glycol, polydiethylene glycol, or glycerol.

Preferably, the plasticizer includes, but is not limited to, one or a combination of two or more of tributyl citrate, trioctyl citrate, acetyl tributyl citrate, acetyl trioctyl citrate, epoxidized soybean oil, a castor-oil-derived ester, or an isosorbic acid diester.

Preferably, the antioxidant includes, but is not limited to, one or two of B215 or 1010.

Preferably, the heat stabilizer includes, but is not limited to, one or two of calcium stearate or zinc stearate.

Preferably, the lubricant includes, but is not limited to, one or a combination of two or more of stearic acid, a monoglyceride, oleic acid, erucamide, and ethylene bis-stearamide.

In a second aspect, a method for preparing the above foamed material is provided, the method comprising:
step I: feeding a starting material into a reactor, then raising the temperature to a set temperature;
step II: conveying liquid carbon dioxide into the reactor via a booster pump to keep carbon dioxide in a supercritical condition.
step III: holding a PHA bead in the high-pressure reactor at a saturation temperature and a saturation pressure for a certain period of time, then rapidly reducing the pressure to the atmospheric pressure by opening the ball valve using a one-step decompression method, so as to give foamed beads.

Preferably, the starting material comprises a substrate; the substrate comprises a PHA, the substrate comprises 4HB ranging from 0 wt % to 60 wt %.

Preferably, the PHA comprises a crystalline PHA and an amorphous PHA.

Preferably, the crystalline PHA comprises 4HB ranging from 2 wt % to 25 wt % (e.g., 0 wt %, 2 wt %, 5 wt %, 7 wt %, 10 wt %, 16 wt %, 20 wt %, or 25 wt %).

Preferably, the amorphous PHA comprises 4HB ranging from 30 wt % to 60 wt % (e.g., 30 wt %, 35 wt %, 40 wt %, 50 wt %, 55 wt %, or 60 wt %).

Preferably, the mass ratio of the crystalline PHA and the amorphous PHA blends is in a range of 90:10 to 10:90 (e.g., 90:10, 80:20, 70:30, 60:40, 50:50, 40:60, 30:70, 20:80, or 10:90), more preferably, the mass ratio of the crystalline PHA and the amorphous PHA blends is in a range of 90:10 to 60:40, even more preferably, the crystalline PHA and the amorphous PHA are blended in a mass ratio of 70:30.

Preferably, the PHA comprises a homopolymer or a copolymer of a monomer constituting the polyhydroxyalkanoate, wherein the monomer constituting the polyhydroxyalkanoate comprises one or two or more of 2-hydroxypropionic acid, 3-hydroxypropionic acid, 3-hydroxybutyric acid, 4-hydroxybutyric acid, 3-hydroxyvaleric acid, 5-hydroxyvaleric acid, 3-hydroxyhexanoic acid, 3-hydroxyheptanoic acid, 3-hydroxyoctanoic acid, 3-hydroxynonanoic acid, 3-hydroxydecanoic acid, or 3-hydroxydodecanoic acid.

Preferably, the PHA includes, but is not limited to, one or a combination of two or more of polyhydroxybutyrate (PHB), poly-3-hydroxyvalerate (PHV), poly-3-hydroxypropionate (P3HP), poly-3-hydroxybutyrate/3-hydroxyvalerate (PHBV), poly-3-hydroxyoctanoate (PHO), poly-3-hydroxynonanoate (PHN), poly-3-hydroxybutyrate/4-hydroxybutyrate (P(3HB-co-4HB) or P34HB), poly-3-hydroxybutyrate/3-hydroxyhexanoate (PHBHHx), a copolymer of hydroxy fatty acids and lactic acid (P(HA-LA)), poly-4-hydroxybutyrate (P4HB), poly-3-hydroxydecanoate (PHD), a copolymer of 3-hydroxybutyrate and 3-hydroxyheptanoate (PHBHHp), a copolymer of 3-hydroxybutyric acid, 4-hydroxybutyric acid and 3-hydroxyvaleric acid (P3HB4HB3HV), or a copolymer of 3-hydroxybutyric acid, 4-hydroxybutyric acid, and 5-hydroxyvaleric acid (P3HB4HB5HV).

The HA in P(HA-LA) is a monomer for constituting the polyhydroxyalkanoate, preferably selected from one, two, or more of 3-hydroxypropionic acid, 3-hydroxybutyric acid, 4-hydroxybutyric acid, 3-hydroxyvaleric acid, 5-hydroxyvaleric acid, 3-hydroxyhexanoic acid, 3-hydroxyheptanoic acid, 3-hydroxyoctanoic acid, 3-hydroxynonanoic acid, 3-hydroxydecanoic acid, or 3- hydroxydodecanoic acid; LA is 2-hydroxypropionic acid.

Preferably, the PHA comprises PHB and/or P(3HB-co-4HB).

Preferably, the crystalline P(3HB-co-4HB) comprises 4HB ranging from 2 wt % to 25 wt % (e.g., 2 wt %, 5 wt %, 7 wt %, 10 wt %, 16 wt %, 20 wt %, or 25 wt %).

Preferably, the amorphous P(3HB-co-4HB) comprises 4HB ranging from 30 wt % to 60 wt % (e.g., 30 wt %, 35 wt %, 40 wt %, 50 wt %, 55 wt %, or 60 wt %).

Preferably, the foamed material further comprises an auxiliary agent; the auxiliary agent includes, but is not limited to, one or a combination of two or more of a chain extender, an anti-hydrolysis stabilizer, a compatibilizer, a melt enhancer, a coupling agent, a solubilizer, a plasticizer, an antioxidant, a heat stabilizer, and a lubricant.

Preferably, the chain extender is an epoxy functional group-containing agent; more preferably, the chain extender includes, but is not limited to, at least one of glycidyl methacrylate, glycidyl acrylate, 3,4-epoxycyclohexyl methacrylate, or an ADR chain extender; even more preferably, the foamed material comprises 0.5% to 3% of the chain extender.

Preferably, the anti-hydrolysis stabilizer includes, but is not limited to, one or a combination of two or more of carbodiimide, isocyanate, epoxy, oxazoline, and anhydride anti-hydrolysis agents.

Preferably, the compatibilizer includes, but is not limited to, one or a combination of two or more of a vinyl acetate polymer, a maleic anhydride graft polymer, or glycidyl methacrylate.

Preferably, the melt enhancer includes, but is not limited to, one or two of an acrylate melt enhancer or a methacrylic acid-butadiene-styrene copolymer.

Preferably, the coupling agent includes, but is not limited to, one or a combination of two or more of a silane coupling agent, a titanate coupling agent, and an aluminate esters coupling agent.

Preferably, the solubilizer includes, but is not limited to, one or a combination of two or more of polyethylene glycol, polydiethylene glycol, or glycerol.

Preferably, the plasticizer includes, but is not limited to, one or a combination of two or more of tributyl citrate, trioctyl citrate, acetyl tributyl citrate, acetyl trioctyl citrate, epoxidized soybean oil, a castor-oil-derived ester, and an isosorbic acid diester.

Preferably, the antioxidant includes, but is not limited to, one or two of B215 or 1010.

Preferably, the heat stabilizer includes, but is not limited to, one or two of calcium stearate or zinc stearate.

Preferably, the lubricant includes, but is not limited to, one or a combination of two or more of stearic acid, a monoglyceride, oleic acid, erucamide, and ethylene bis-stearamide.

Preferably, in step I, the set temperature is any value in the range of 50° C. to 150° C., e.g., 50, 60, 70, 80, 90, 100, 110, 120, 130, 140, or 150° C.

Preferably, in step II, the set pressure in the reactor is in the range of 8 MPa to 11 MPa, e.g., 8, 9, 10, or 11 MPa.

Preferably, in step III, the PHA bead is held in the high-pressure reactor for 20 min to 40 min, e.g., 20, 25, 30, 35, or 40 min.

In a third aspect, use of the above foamed material in a product requiring a material with biodegradability and cushion performance is provided.

Preferably, the product includes, but is not limited to, high-tech appliances, packaging materials of electronic equipment, sports shoe sole materials, carpet materials, soft package materials of automotive interiors, sewage treatment materials, or medical microporous foamed materials.

By providing the above embodiments, the present invention possesses the following advantages:

The elastic property, the open/closed cell structure, the thickness of the cell wall, and the cell size of the foamed material, which depend on the expansion ratio, have a close relationship with the resilience. The foamed material acquired by the present application has a high expansion ratio, more closed cells, and a wider processing window for stable production. The material has good compression elasticity, and can thus be used as a cushion material in product packaging and protection, featuring cost-efficiency and a higher foaming ratio.

The term “and/or” described herein encompasses all combinations of the items connected by the term, and each combination should be deemed to have been individually listed herein. For example, “A and/or B” encompasses “A”, “A and B”, and “B”. For another example, “A, B, and/or C” encompasses “A”, “B”, “C”, “A and B”, “A and C”, “B and C”, and “A and B and C”.

The term “comprises”, “comprising” or “includes” described herein is an open-ended description that includes the specified ingredients or steps as described, as well as other specified ingredients or steps that do not substantially affect the technical effect.

### BRIEF DESCRIPTION OF THE DRAWINGS

FIG. 1 illustrates the correlation between the heating temperature for foaming and the storage modulus, wherein CryPHA denotes the crystalline PHA, and AmoPHA denotes amorphous PHA;

FIG. 2 illustrates the correlation between the heating temperature for foaming and the loss modulus, wherein CryPHA denotes the crystalline PHA, and AmoPHA denotes amorphous PHA;

FIG. 3 illustrates the correlation between the heating temperature for foaming and the tan δ, wherein CryP34HB denotes the crystalline P(3HB-co-4HB), and AmoP34HB denotes amorphous P(3HB-co-4HB);

FIG. 4 illustrates the correlation between the heating temperature for foaming and the tan δ, wherein CryPHB denotes the crystalline PHB, and AmoP34HB denotes amorphous P(3HB-co-4HB);

FIG. 5 illustrates the correlation between the total 4HB content in the material for foaming and tan δ at different heating temperatures, wherein copolymer denotes the microorganism-produced source product P(3HB-co-4HB) for the biodegradable PHA polymer, and mixture denotes a mixture of crystalline and amorphous P(3HB-co-4HB);

FIG. 6 illustrates a structural schematic of materials obtained by blending crystalline PHB and amorphous P(3HB-co-4HB) in different mass ratios under an SEM (scanning electron microscope), wherein CryPHB denotes the crystalline PHB, and AmoP34HB denotes amorphous P(3HB-co-4HB);

FIG. 7 illustrates a structural schematic of materials obtained by blending crystalline P(3HB-co-4HB) and amorphous P(3HB-co-4HB) in different mass ratios under an SEM (scanning electron microscope), wherein CryP34HB denotes the crystalline P(3HB-co-4HB), and AmoP34HB denotes amorphous P(3HB-co-4HB);

FIG. 8 illustrates the correlation between the expansion ratio and the content of amorphous P(3HB-co-4HB), wherein CryPHB denotes the crystalline PHB, CryP34HB denotes the crystalline P(3HB-co-4HB), and AmoP34HB denotes amorphous P(3HB-co-4HB);

FIG. 9 illustrates the correlation between the cell size and the content of amorphous P(3HB-co-4HB), wherein CryPHB denotes the crystalline PHB, CryP34HB denotes the crystalline P(3HB-co-4HB), and AmoP34HB denotes amorphous P(3HB-co-4HB);

FIG. 10 illustrates the correlation between the cell density and the content of amorphous P(3HB-co-4HB), wherein CryPHB denotes the crystalline PHB, CryP34HB denotes the crystalline P(3HB-co-4HB), and AmoP34HB denotes amorphous P(3HB-co-4HB).

### DETAILED DESCRIPTION

The embodiments in the examples of the present invention will be described clearly and completely below with reference to the drawings. It is apparent that the described examples are only a part of the examples of the present invention, but not all of them. Based on the examples of the present invention, all other examples obtained by those of ordinary skills in the art without creative work shall fall within the protection scope of the present invention.

Unless otherwise specified, all materials used in the examples of the present invention are commercially available.

Unless otherwise specified, the parts, percentages, or ratios described in the examples of the present invention are on mass basis.

The crystalline P(3HB-co-4HB) referred to in the examples is P(3HB-co-4HB) containing 4HB ranging from 2 wt % to 25 wt %; the amorphous P(3HB-co-4HB) is P(3HB-co-4HB) containing 4HB ranging from 30 wt % to 60 wt %.

### Example 1

Provided is a biodegradable polyhydroxyalkanoate (PHA) foamed bead prepared as follows:
Step I: A PHB granules was fed into an reactor, and the temperature was then raised by a heating system to a set temperature of 150° C.
Step II: Liquid carbon dioxide was conveyed into the reactor via a booster pump to keep carbon dioxide in a supercritical condition at a pressure of 11 MPa in the reactor.
Step III: The PHA bead was held in the high-pressure reactor at a saturation temperature of 150° C. and a saturation pressure of 11 MPa for 40 min, and the pressure was rapidly reduced to the atmospheric pressure by opening the ball valve using a one-step decompression method, so as to prepare a biodegradable polyhydroxyalkanoate (PHA) foamed bead.

### Example 2

Provided is a biodegradable polyhydroxyalkanoate (PHA) foamed bead prepared as follows:
Step I: A crystalline P(3HB-co-4HB) granules containing 10% of 4HB was fed into an reactor, and the temperature was then raised by a heating system to a set temperature of 130° C.
Step II: Liquid carbon dioxide was conveyed into the reactor via a booster pump to keep carbon dioxide in a supercritical condition at a pressure of 10 MPa in the reactor.
Step III: The PHA bead was held in the high-pressure reactor at a saturation temperature of 130° C. and a saturation pressure of 10 MPa for 30 min, and the pressure was rapidly reduced to the atmospheric pressure by opening the ball valve using a one-step decompression method, so as to prepare a biodegradable polyhydroxyalkanoate (PHA) foamed bead.

Provided is a biodegradable polyhydroxyalkanoate (PHA) foamed bead prepared as follows:
Step I: A crystalline P(3HB-co-4HB) granules containing 10% of 4HB was fed into an reactor, and the temperature was then raised by a heating system to a set temperature of 120° C.
Step II: Liquid carbon dioxide was conveyed into the reactor via a booster pump to keep carbon dioxide in a supercritical condition at a pressure of 10 MPa in the reactor.
Step III: The PHA bead was held in the high-pressure reactor at a saturation temperature of 120° C. and a saturation pressure of 10 MPa for 30 min, and the pressure was rapidly reduced to the atmospheric pressure by opening the ball valve using a one-step decompression method, so as to prepare a biodegradable polyhydroxyalkanoate (PHA) foamed bead.

### Example 4

Provided is a biodegradable polyhydroxyalkanoate (PHA) foamed bead prepared as follows:
Step I: A crystalline P(3HB-co-4HB) granules containing 16% of 4HB was fed into an reactor, and the temperature was then raised by a heating system to a set temperature of 100° C.
Step II: Liquid carbon dioxide was conveyed into the reactor via a booster pump to keep carbon dioxide in a supercritical condition at a pressure of 10 MPa in the reactor.
Step III: The PHA bead was held in the high-pressure reactor at a saturation temperature of 100° C. and a saturation pressure of 10 MPa for 30 min, and the pressure was rapidly reduced to the atmospheric pressure by opening the ball valve using a one-step decompression method, so as to prepare a biodegradable polyhydroxyalkanoate (PHA) foamed bead.

### Example 5

Provided is a biodegradable polyhydroxyalkanoate (PHA) foamed bead prepared as follows:
Step I: A crystalline P(3HB-co-4HB) granules containing 16% of 4HB was fed into an reactor, and the temperature was then raised by a heating system to a set temperature of 100° C.
Step II: Liquid carbon dioxide was conveyed into the reactor via a booster pump to keep carbon dioxide in a supercritical condition at a pressure of 9 MPa in the reactor.
Step III: The PHA bead was held in the high-pressure reactor at a saturation temperature of 100° C. and a saturation pressure of 9 MPa for 30 min, and the pressure was rapidly reduced to the atmospheric pressure by opening the ball valve using a one-step decompression method, so as to prepare a biodegradable polyhydroxyalkanoate (PHA) foamed bead.

### Example 6

Provided is a biodegradable polyhydroxyalkanoate (PHA) foamed bead prepared as follows:
Step I: A P(3HB-co-4HB) elastomer granules containing 30% of 4HB was fed into an reactor, and the temperature was then raised by a heating system to a set temperature of 70° C.
Step II: Liquid carbon dioxide was conveyed into the reactor via a booster pump to keep carbon dioxide in a supercritical condition at a pressure of 8 MPa in the reactor.
Step III: The PHA bead was held in the high-pressure reactor at a saturation temperature of 70° C. and a saturation pressure of 8 MPa for 20 min, and the pressure was rapidly reduced to the atmospheric pressure by opening the ball valve using a one-step decompression method, SO as to prepare a biodegradable polyhydroxyalkanoate (PHA) foamed bead.

### Example 7

Provided is a biodegradable polyhydroxyalkanoate (PHA) foamed bead prepared as follows:
Step I: A crystalline poly-3-hydroxybutyrate/4-hydroxybutyrate P(3HB-co-4HB) granules containing 10% of 4HB and an amorphous poly-3-hydroxybutyrate/4-hydroxybutyrate P(3HB-co-4HB) granules containing 50% of 4HB were fed into an reactor in a 70/30 mass ratio, and the temperature was then raised by a heating system to a set temperature of 130° C.
Step II: Liquid carbon dioxide was conveyed into the reactor via a booster pump to keep carbon dioxide in a supercritical condition at a pressure of 10 MPa in the reactor.
Step III: The PHA bead was held in the high-pressure reactor at a saturation temperature of 130° C. and a saturation pressure of 10 MPa for 30 min, and the pressure was rapidly reduced to the atmospheric pressure by opening the ball valve using a one-step decompression method, so as to prepare a biodegradable polyhydroxyalkanoate (PHA) foamed bead.

The following performance tests were conducted on the foamed materials prepared in Examples 1-7 of the present invention, and the specific results are shown in Table 1.

TABLE 1
Major performance parameters of the foamed materials
prepared in Examples 1-7

| | Foam | Expansion | Cell | Cell |
|---|---|---|---|---|
| | Density | ratio | size | density |
| Item | (g/cm³) | (Φ) | (μm) | (cell/cm³) |
| Example 1 | 0.350 | 6 | 20 | 8.0 × 10⁹ |
| Example 2 | 0.060 | 21 | 85 | 2.2 × 10⁸ |
| Example 3 | 0.180 | 7 | 25 | 2.8 × 10⁹ |
| Example 4 | 0.042 | 30 | 140 | 2.0 × 10⁷ |
| Example 5 | 0.069 | 18 | 90 | 8.5 × 10⁷ |
| Example 6 | 0.270 | 5 | 105 | 9.0 × 10⁶ |
| Example 7 | 0.050 | 25 | 110 | 8.7 × 10⁷ |

It is learned from Examples 2 and 3 and Examples 4 and 5 that at a proper pressure and a temperature around the melting point, foamed materials with better foaming performance (higher expansion ratio) can be acquired, and the optimal foaming temperature of materials with different 4HB contents are shown in Table 2. The Tm and Tg can be determined by DSC, and the optimal foaming temperature can be determined by a temperature corresponding to the maximum slope at the inflection point of the DMA curve, e.g., FIG. 4. As can be seen from Examples 2-6, in the crystalline PHA, the foaming performance become better as the content of 4HB increases. It is learned from Example 7 that the blending of a crystalline PHA with an amorphous PHA may also produce a foamed material with good foaming performance.

TABLE 2
Foaming temperature of materials with different 4HB contents

| | | | Foaming |
|---|---|---|---|
| | | | temperature range |
| 4HB content (%) | Tm (° C.) | Tg (° C.) | (° C.) |
| 2.1 | 175 | 2 | 145 |
| 7 | 150 | −1 | 140-135 |
| 10 | 145 | −7 | 130-125 |
| 16 | 140 | −10 | 110-90 |
| 25 | 130 | −15 | 100-70 |
| 30 | — | −22 | 100-50 |

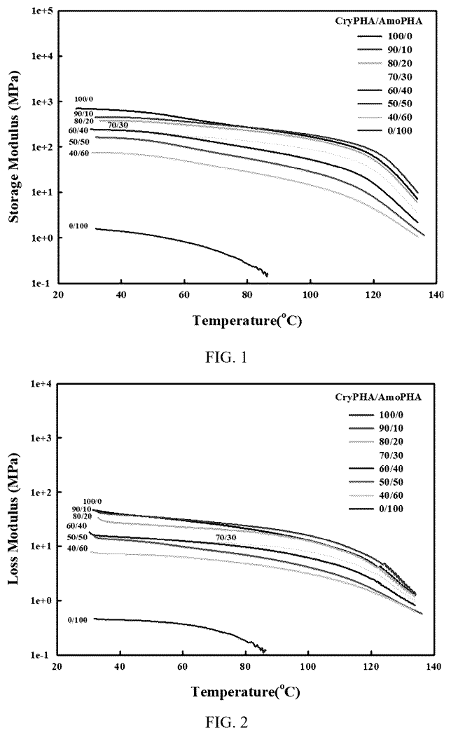

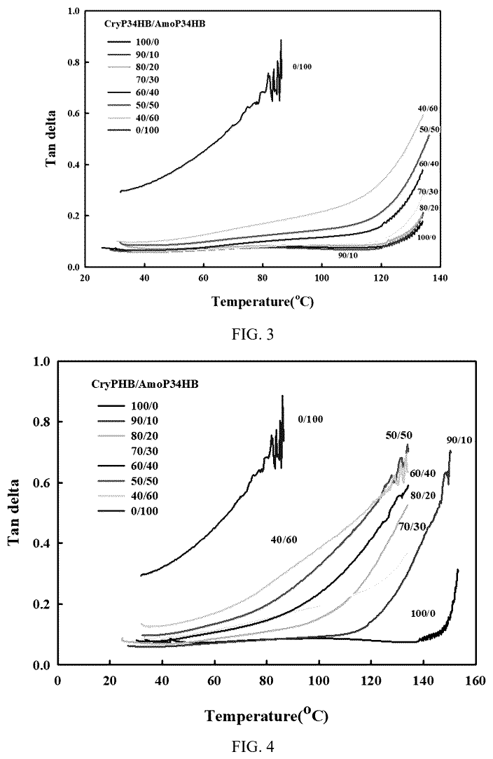

The nucleation and cell growth of PHA foams are influenced by the crystalline/amorphous structure and viscoelasticity of the polymer, and in particular, the nucleation and continuous growth of cells require proper crystallinity and tan δ values in foaming conditions. The loss tangent (tan δ) of PHA was determined on a dynamic mechanical thermal analyzer (TA, DMA Q800/2980, Delaware, USA), with a temperature range of 30° C. to 160° C., an oscillation frequency set at 1 MHz, and a sheet size of 1 mm×2.5 mm. The tan δ is the ratio of loss modulus to storage modulus, which varies greatly at different transition temperatures. The tan δ value can be used to determine the melt strength and the foamability of the corresponding materials. The results are shown in FIGS. 1-4. It is learned from FIGS. 3 and 4 that different mass ratios of the crystalline PHA (PHB or P(3HB-co-4HB)) to the amorphous PHA (P(3HB-co-4HB)) lead to different optimal foaming temperatures. When the addition amount of amorphous P(3HB-co-4HB) is less than 40%, a wider foaming temperature range can be acquired, while the addition of only amorphous P(3HB-co-4HB) will lead to a higher tan δ value and failure of foaming.

In addition, the applicant has also explored the tan δ values of foamed beads obtained using poly-3-hydroxybutyrate/4-hydroxybutyrate (P(3HB-co-4HB)) with different 4HB contents. As shown in FIG. 5, copolymer denotes the microorganism-produced source product P(3HB-co-4HB) for the biodegradable PHA polymer, and mixture denotes a mixture of crystalline and amorphous P(3HB-co-4HB). It can be seen that the tan δ value mainly varies with the 4HB content and the temperature. Excessive 4HB content or excessive temperature may lead to a reduction in the foaming performance or even to failure of foaming.

### Example 8

Provided is a biodegradable polyhydroxyalkanoate (PHA) foamed bead prepared as follows:
Step I: A crystalline PHB granules and an amorphous poly-3-hydroxybutyrate/4-hydroxybutyrate P(3HB-co-4HB) granules, containing 50% of 4HB, were fed into an reactor in different mass ratios (100/0, 90/10, 80/20, 70/30, 60/40, 50/50, 40/60, 30/70, 20/80, 10/90, or 0/100), and the temperature was then raised by a heating system to a set temperature of 150° C.
Step II: Liquid carbon dioxide was conveyed into the reactor via a booster pump to keep carbon dioxide in a supercritical condition at a pressure of 11 MPa in the reactor.
Step III: The PHA bead was held in the high-pressure reactor at a saturation temperature (150° C.) and a saturation pressure (11 MPa) for 40 min, and the pressure was rapidly reduced to the atmospheric pressure by opening the ball valve using a one-step decompression method, so as to prepare a biodegradable polyhydroxyalkanoate (PHA) foamed bead.

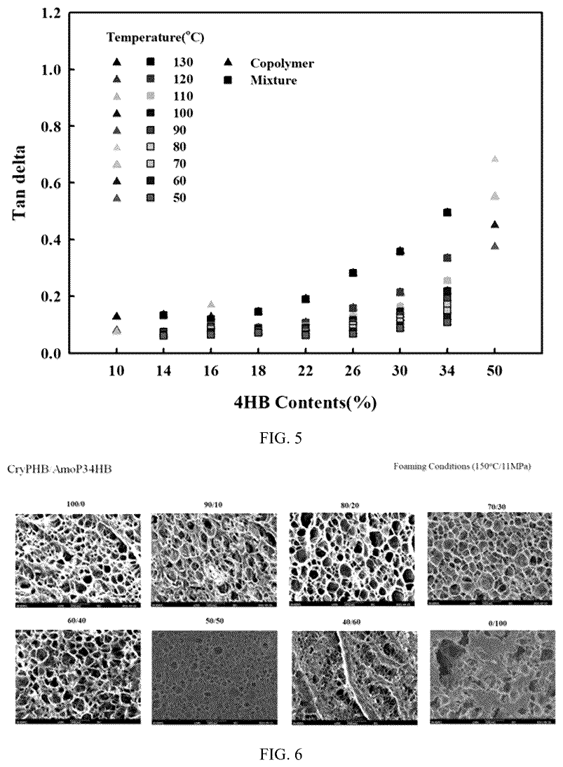

The structure of the foamed beads was further observed under an SEM, and the results are shown in FIG. 6. As can be seen from FIG. 6, at an amorphous P(3HB-co-4HB) addition amount of less than 40%, a remarkable porous structure with a relatively regular cell size was observed. With the increase of the addition amount of amorphous P(3HB-co-4HB), the foamed material produces thicker cell walls and more closed cells, thus improving the compression elasticity of the foamed material. However, when only amorphous P(3HB-co-4HB) was added, substantially no obvious porous structure was observed.

### Example 9

Provided is a biodegradable polyhydroxyalkanoate (PHA) foamed bead prepared as follows:
Step I: A crystalline poly-3-hydroxybutyrate/4-hydroxybutyrate P(3HB-co-4HB) granules and an amorphous poly-3-hydroxybutyrate/4-hydroxybutyrate P(3HB-co-4HB) granules, containing 50% of 4HB, were fed into an reactor in different mass ratios (100/0, 90/10, 80/20, 70/30, 60/40, 50/50, 40/60, 30/70, 20/80, 10/90, or 0/100), and the temperature was then raised by a heating system to a set temperature of 130° C.
Step II: Liquid carbon dioxide was conveyed into the reactor via a booster pump to keep carbon dioxide in a supercritical condition at a pressure of 10 MPa in the reactor.
Step III: The PHA bead was held in the high-pressure reactor at a saturation temperature (130° C.) and a saturation pressure (10 MPa) for 30 min, and the pressure was rapidly reduced to the atmospheric pressure by opening the ball valve using a one-step decompression method, so as to prepare a biodegradable polyhydroxyalkanoate (PHA) foamed bead.

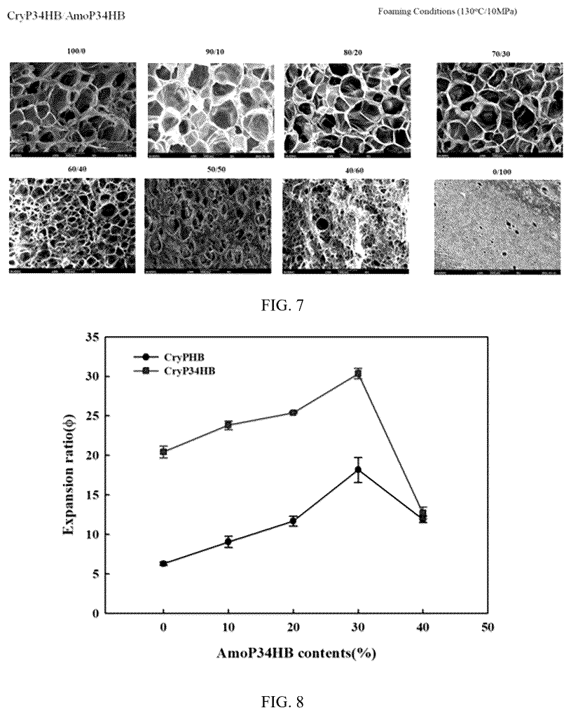

The structure of the foamed beads was further observed under an SEM, and the results are shown in FIG. 7. As can be seen from FIG. 7, at an amorphous P(3HB-co-4HB) addition amount of less than 40%, a remarkable and stable porous structure with a regular cell size was observed. With the increase of the addition amount of amorphous P(3HB-co-4HB), the foamed material produces thicker cell walls and more closed cells, thus improving the compression elasticity of the foamed material. When only amorphous P(3HB-co-4HB) was added, no obvious porous structure was observed.

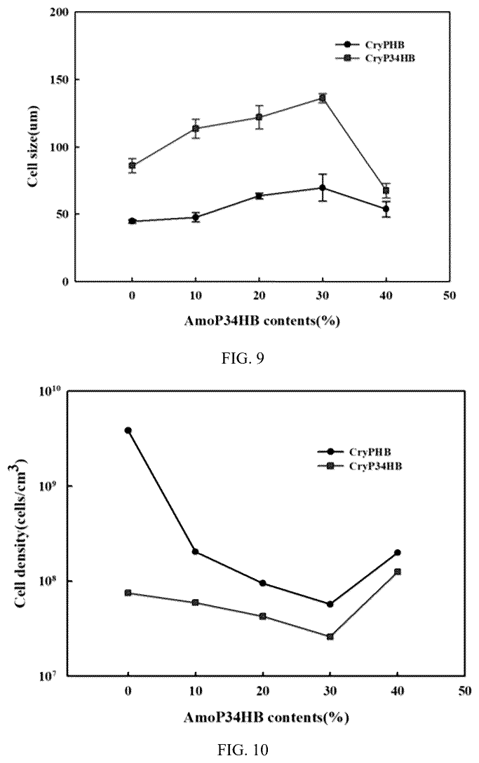

The performance of the foamed beads obtained in Examples 8 and 9 were examined. The expansion ratios are shown in FIG. 8, the cell sizes are shown in FIG. 9, and cell densities are shown in FIG. 10. Due to the poor thermal stability, narrow processing window, and low crystallization rate of PHAs, the formation of spherical crystals with large sizes may lead to high fragility, and PHAs are continuously crystallized during the process of solidification, thus posing difficulties to the stable production of molded products. Accordingly, it is necessary to select a material having better foaming performance and good compression elasticity as the cushioning material for product packaging and protection, and therefore, a material having a high expansion ratio is required. The elastic property, the open/closed cell structure, the thickness of the cell wall, and the cell size of the foamed material, which depend on the expansion ratio, have a close relationship with the resilience. From the results shown in FIGS. 8 and 9, it is learned that when the proportion of amorphous P(3HB-co-4HB) added was 30%, the expansion ratio was the highest and the cell size was the greatest, and that the expansion ratio and the cell size of the crystalline P(3HB-co-4HB) were higher than those of the crystalline PHB. As shown in FIG. 10, when the proportion of amorphous P(3HB-co-4HB) added was 0 to 40%, the cell density of the foamed materials was around 10⁸ cells/cm³, suggesting that the foamed materials obtained by the above methods can provide excellent compression elasticity, with cost-efficiency and a higher foaming ratio.

In summary, from the results of Tables 1 and 2 and FIGS. 1-10, it can be seen that: PHA and P(3HB-co-4HB) with a low 4HB content and a crystal structure can be foamed around the melting temperature, but with the increase of the 4HB content, the range of the foaming temperature becomes wider, the expansion ratio and the cell size are also increased; P(3HB-co-4HB) elastomers with a high 4HB content may have a relatively wider foaming window around the temperature at which the chain motion occurs, as well as a stable cell size and good uniformity, thus improving the compression elasticity. According to the performance of the materials prepared in the above examples and the performance requirements listed in Table 3, the above materials can be used in high-tech appliances, packaging materials of electronic equipment, sports shoe sole materials, carpet materials, soft package materials of automotive interiors, sewage treatment materials, and medical microporous foamed

TABLE 3
Properties required by some applications

| | | | Cell | Cell | |
|---|---|---|---|---|---|
| | | Expansion | size | density | Resilience |
| Application | Density | ratio | (μm) | (cells/cm³) | (%) |
| Foamed | Low | 10-40 | >100 | <10⁶ | |
| material for | density | | | | |
| electronic | | | | | |
| device | | | | | |
| packaging | | | | | |
| Foamed | Medium | 4-10 | 30-100 | 10⁷-10⁸ | >45 |
| material for | density | | | | |
| sports shoe | | | | | |
| sole | | | | | |
| Microporous | Medium | 1-10 | <30 | 10⁸-10⁹ | |
| foamed | and high | | | | |
| material for | density | | | | |
| medical use | | | | | |

The preferred embodiments of the present invention are described in detail above, which, however, are not intended to limit the present invention. Within the scope of the technical concept of the present invention, multiple simple modifications can be made to the embodiments herein, including combining various technical features in any other suitable manner. Such simple modifications and combinations should also be construed as part of the disclosure of the present invention and fall within the scope of protection.

1. A foamed material comprising a substrate, wherein the substrate comprises a PHA, the substrate comprises 4HB ranging from 0 wt % to 60 wt %.

2. The foamed material according to claim 1, wherein the PHA comprises a crystalline PHA and/or an amorphous PHA; the crystalline PHA comprises 4HB ranging from 0 wt % to 25 wt %; the amorphous PHA comprises 4HB ranging from 30 wt % to 60 wt %.

3. The foamed material according to claim 2, wherein the substrate comprises the crystalline PHA and the amorphous PHA; the mass ratio of the crystalline PHA and the amorphous PHA blends is in a range of 90:10 to 10:90.

4. The foamed material according to claim 1, wherein the PHA comprises a homopolymer or a copolymer of a monomer constituting the polyhydroxyalkanoate; the monomer constituting the polyhydroxyalkanoate comprises one or two or more of 2-hydroxypropionic acid, 3-hydroxypropionic acid, 3-hydroxybutyric acid, 4-hydroxybutyric acid, 3-hydroxyvaleric acid, 5-hydroxyvaleric acid, 3-hydroxyhexanoic acid, 3-hydroxyheptanoic acid, 3-hydroxyoctanoic acid, 3-hydroxynonanoic acid, 3-hydroxydecanoic acid, or 3-hydroxydodecanoic acid.

5. The foamed material according to claim 4, wherein the PHA comprises one or a combination of two or more of PHB, PHV, P3HP, PHBV, PHO, PHN, P(3HB-co-4HB), PHBHHx, P(HA-LA), P4HB, PHD, PHBHHp, P3HB4HB3HV, or P3HB4HB5HV.

6. The foamed material according to claim 1, wherein the foam density of the foamed material is in a range of 0.04 g/cm³ to 0.35 g/cm³, the expansion ratio of the foamed material is in a range of 4 to 30.

7. The foamed material according to claim 1, wherein the cell size of the foamed material is in a range of 20 μm to 145 μm, the cell density of the foamed material is in a range of 5.8×10⁷ cells/cm³ to 9.7×10¹⁰ cells/cm³.

8. The foamed material according to any one of claims 1-7, wherein the foamed material further comprises an auxiliary agent; the auxiliary agent comprises one or a combination of two or more of a chain extender, an anti-hydrolysis stabilizer, a compatibilizer, a melt enhancer, a coupling agent, a solubilizer, a plasticizer, an antioxidant, a heat stabilizer, and a lubricant.

9. The foamed material according to claim 8, wherein the chain extender comprises one or a combination of two or more of an epoxy-functional chain extender, an oxazoline chain extender, and an isocyanate chain extender.

10. The foamed material according to claim 9, wherein the chain extender is an epoxy functional group-containing agent; the chain extender is selected from at least one of glycidyl methacrylate, glycidyl acrylate, 3,4-epoxycyclohexyl methacrylate, and an ADR chain extender.

11. The foamed material according to claim 10, wherein the foamed material comprises 0.5% to 3% of the chain extender.

12. A method for preparing the foamed material according to any one of claims 1-11, comprising:
step I: feeding a starting material into a reactor, then raising the temperature to a set temperature;
step II: conveying liquid carbon dioxide into the reactor via a booster pump to keep carbon dioxide in a supercritical condition;
step III: holding a PHA bead in the high-pressure reactor at a saturation temperature and a saturation pressure for a certain period of time, then reducing the pressure to the atmospheric pressure by opening the ball valve using a one-step decompression method, so as to give foamed beads,
wherein the starting material comprises a substrate; the substrate comprises a PHA, the substrate comprises 4HB ranging from 0 wt % to 60 wt %.

13. The method according to claim 12, wherein in step I, the set temperature is in a range of 50° C. to 150° C.

14. The method according to claim 12, wherein in step II, the set pressure in the reactor is in a range of 8 MPa to 11 MPa.

15. The method according to claim 12, wherein in step III, the PHA bead is held in the high-pressure reactor for 20 min to 40 min.

16. Use of the foamed material of any one of claims 1-11 in a product requiring a material with biodegradability and cushion performance, wherein the product comprises high-tech appliances, packaging materials of electronic equipment, sports shoe sole materials, carpet materials, soft package materials of automotive interiors, sewage treatment materials, or medical microporous foamed materials.

1. A foamed material comprising a substrate, wherein the substrate comprises a PHA, the substrate comprises 4HB ranging from 0 wt % to 60 wt %.

2. The foamed material according to claim 1, wherein the PHA comprises a crystalline PHA and/or an amorphous PHA; the crystalline PHA comprises 4HB ranging from 0 wt % to 25 wt %; the amorphous PHA comprises 4HB ranging from 30 wt % to 60 wt %.

3. The foamed material according to claim 21, wherein the substrate comprises the crystalline PHA and the amorphous PHA; the mass ratio of the crystalline PHA and the amorphous PHA blends is in a range of 90:10 to 10:90.

4. The foamed material according to claim 1, wherein the PHA comprises a homopolymer or a copolymer of a monomer constituting the polyhydroxyalkanoate; the monomer constituting the polyhydroxyalkanoate comprises one or two or more of 2-hydroxypropionic acid, 3-hydroxypropionic acid, 3-hydroxybutyric acid, 4-hydroxybutyric acid, 3-hydroxyvaleric acid, 5-hydroxyvaleric acid, 3-hydroxyhexanoic acid, 3-hydroxyheptanoic acid, 3-hydroxyoctanoic acid, 3-hydroxynonanoic acid, 3-hydroxydecanoic acid, or 3-hydroxydodecanoic acid.

5. The foamed material according to claim 4, wherein the PHA comprises one or a combination of two or more of PHB, PHV, P3HP, PHBV, PHO, PHN, P(3HB-co-4HB), PHBHHx, P(HA-LA), P4HB, PHD, PHBHHp, P3HB4HB3HV, or P3HB4HB5HV.

6. The foamed material according to claim 1, wherein the foam density of the foamed material is in a range of 0.04 g/cm³ to 0.35 g/cm³, the expansion ratio of the foamed material is in a range of 4 to 30.

7. The foamed material according to claim 1, wherein the cell size of the foamed material is in a range of 20 μm to 145 μm, the cell density of the foamed material is in a range of 5.8×10⁷ cells/cm³ to 9.7×10¹⁰ cells/cm³.

8. The foamed material according to claim 1, wherein the foamed material further comprises an auxiliary agent; the auxiliary agent comprises one or a combination of two or more of a chain extender, an anti-hydrolysis stabilizer, a compatibilizer, a melt enhancer, a coupling agent, a solubilizer, a plasticizer, an antioxidant, a heat stabilizer, and a lubricant.

9. The foamed material according to claim 8, wherein the chain extender comprises one or a combination of two or more of an epoxy-functional chain extender, an oxazoline chain extender, and an isocyanate chain extender.

10. The foamed material according to claim 9, wherein the chain extender is an epoxy functional group-containing agent; the chain extender is selected from at least one of glycidyl methacrylate, glycidyl acrylate, 3,4-epoxycyclohexyl methacrylate, and an ADR chain extender.

11. The foamed material according to claim 8, wherein the foamed material comprises 0.5% to 3% of the chain extender.

12. A method for preparing the foamed material claim 1, comprising:
step I: feeding a starting material into a reactor, then raising the temperature to a set temperature;
step II: conveying liquid carbon dioxide into the reactor via a booster pump to keep carbon dioxide in a supercritical condition;
step III: holding a PHA bead in the high-pressure reactor at a saturation temperature and a saturation pressure for a certain period of time, then reducing the pressure to the atmospheric pressure by opening the ball valve using a one-step decompression method, so as to give foamed beads,
wherein the starting material comprises a substrate; the substrate comprises a PHA, the substrate comprises 4HB ranging from 0 wt % to 60 wt %.

13. The method according to claim 12, wherein in step I, the set temperature is in a range of 50° C. to 150° C.

14. The method according to claim 12, wherein in step II, the set pressure in the reactor is in a range of 8 MPa to 11 MPa.

15. The method according to claim 12, wherein in step III, the PHA bead is held in the high-pressure reactor for 20 min to 40 min.

16. A product, comprising the foamed material of claim 1, wherein the product comprises high-tech appliances, packaging materials of electronic equipment, sports shoe sole materials, carpet materials, soft package materials of automotive interiors, sewage treatment materials, or medical microporous foamed materials.

17. The method according to claim 12, wherein the PHA comprises a crystalline PHA and/or an amorphous PHA; the crystalline PHA comprises 4HB ranging from 0 wt % to 25 wt %; the amorphous PHA comprises 4HB ranging from 30 wt % to 60 wt %.

18. The method according to claim 12, wherein the substrate comprises the crystalline PHA and the amorphous PHA; the mass ratio of the crystalline PHA and the amorphous PHA blends is in a range of 90:10 to 10:90.

19. The method according to claim 12, wherein the PHA comprises a homopolymer or a copolymer of a monomer constituting the polyhydroxyalkanoate;
the monomer constituting the polyhydroxyalkanoate comprises one or two or more of 2-hydroxypropionic acid, 3-hydroxypropionic acid, 3-hydroxybutyric acid, 4-hydroxybutyric acid, 3-hydroxyvaleric acid, 5-hydroxyvaleric acid, 3-hydroxyhexanoic acid, 3-hydroxyheptanoic acid, 3-hydroxyoctanoic acid, 3-hydroxynonanoic acid, 3-hydroxydecanoic acid, or 3-hydroxydodecanoic acid.

20. The method according to claim 19, wherein the PHA comprises one or a combination of two or more of PHB, PHV, P3HP, PHBV, PHO, PHN, P(3HB-co-4HB), PHBHHx, P(HA-LA), P4HB, PHD, PHBHHp, P3HB4HB3HV, or P3HB4HB5HV.
